(19) United States
(12) Patent Application Publication
(10) Pub. No.: US 2006/0237512 A1
(43) Pub. Date: Oct. 26, 2006

(54) Tacker apparatus with a nail stopper

(75) Inventors: Jae-Sung Kim, Seoul (KR); Sang-Chun Lee, Seongnam (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5554, US

(73) Assignee: JEIL TACKER CO., LTD.

(21) Appl. No.: 11/255,407

(22) Filed: Oct. 20, 2005

(30) Foreign Application Priority Data
Apr. 20, 2005 (KR) 20-2005-10997

(51) Int. Cl. B25C 1/04

(52) U.S. Cl. 227/8; 227/130

(57) ABSTRACT

A nail retainer for a tacker comprises a guider receiving nails transmitted from a magazine, guiding the nails received therein, and comprising a hole formed through a designated portion of the upper surface thereof; and a stopper axially connected to the hole of the guider, moving together with the movement of a contact arm to prevent the nails received in the guider from dropping when the contact arm moves forward, and releasing a nail-stopping motion for preventing the nails from dropping when the contact arm moves backward. The nail retainer does not cause failure due to the attraction of iron filings remaining in a magazine or a guider onto the surface of the member, differing from conventional nail retainers made of a magnetic material, and moves together with the movement of a contact arm to reliably prevent a nail from dropping, thereby increasing the consumer's reliability.

Pursuant to 35 U.S.C. § 119(a), this application claims the benefit of earlier filing date and right of priority to Korean Patent Application No. 20-2005-0010997, filed on Apr. 20, 2005, the content of which is hereby incorporated by reference herein in its entirety.

### BACKGROUND OF THE INVENTION

1. Field of the Invention

The present invention relates to a nail retainer for a tacker, and more particularly to a nail retainer, for a tacker, having a guide with a through hole formed through the upper end thereof and a stopper connected to the guide via the through hole for preventing the final remaining nail from dropping, instead of a magnetic member attracting nails, so as to prevent the nail from dropping before firing.

2. Description of the Related Art

As well known to those skilled in the art, a tacker-nailer, a stapler, and a pinner, which are used in construction and interior works, are pneumatic machines for fastening a wooden article to another wooden article, a wooden article to a plastic article, a wooden article to a steel article, or a wooden article to a concrete article, and are used in various works, such as exterior works and aluminum chassis works.

Generally, a tacker comprises a body having a piston and a cylinder installed therein, a cover for providing air to, and eliminating air from, the piston, a magazine loaded with nails, staples or pins, and a guide for launching the nails, a safety device for ensuring safe operation, a latch device for loading the tacker with nails, a bracket for connecting the magazine to a handle grip to obtain the firm structure of the tacker, and a trigger for driving the tacker.

In the above tacker, the trigger is operated to move the piston installed in the body, thereby allowing the nails or the staples loaded in the magazine to go through a desired position of an object through the guide.

More particularly, with reference to FIG. 1, single and continuous firing methods using a conventional tacker, such as a nailer, will be illustrated. A safety device is provided at the front end of the tacker and is connected to a connector 100 which is installed in a guide. If the connector 100 does not move to the rear end of the tacker in the single or continuous firing position, nails are not launched. Thereby, the tacker prevents accidents caused by user carelessness.

In the single firing operation using the conventional tacker, the tacker has a position shown in FIG. 1. In the above position, a user puts the connector 100 of the tacker into contact with a target site of an object, and presses the tacker against the target site. Then, the connector 100 moves towards an operating member 10, and the rear end of the connector 100 moves a pushing plate 94, connected to the lower end of a trigger 92 by a connection pin 96, to the operating member 10 by a designated length.

Thereby, due to the backward movement of the pushing plate 94, the rear surface of the pushing plate 94 inserts a valve rod 12, protruded from the operating member 10, into the operating member 10, by a designated length.

Under the above state, when the user pulls the trigger 92, the lower end of the trigger 92 moves centering on a rotating pin 97 fastened to the upper end of the trigger 92. Then, a rear contact plane 94b of the pushing plate 94 connected to the trigger 92 by the pin 96 completely inserts the valve rod 12 into the operating member 10. When the valve rod 12 is completely inserted into the operating member 10, tacker pins or nails loaded in the guide are launched forward.

The pushing plate 94 is connected to the lower end of the trigger 92 by the pin 96, but, under the condition that the connector 100 has not move toward the operating member 10, the pushing plate 94 cannot completely press the valve rod 12 into the operating member 10, thereby preventing the tacker pins or the nails from being launched. Therefore, when the trigger 92 is pulled under the condition that a contact point between the upper front plane 94c of the pushing plate 94 and the connector 100 is a support point, the upper end of the pushing plate 94 cannot move forward due to the contact with the connector 100, and the lower end of the pushing plate 94 moves due to the rotation of the trigger 92, and presses the valve rod 12.

In the continuous firing operation using the conventional tacker, in which a user does not fire one tacker pin but fires several tacker pins toward a broad area of an object in a short time, the user presses the front end of the tacker to a target site under the condition that the user pulls the trigger 92, thereby causing the connector 100 to move toward the operating member 10 (in the direction of B) and the tacker pins to be launched. The fundamental principle of the continuous firing operation is the same as that of the single firing operation. However, in the continuous firing operation, the connector 100 does not contact the object first, but is pressed onto the target site of the object under the condition that the trigger 92 is pulled first.

If one nail 2 is pushed upwardly from the magazine and stands by in a guider 200 (with reference to FIG. 2) for shooting, when the front end of the tacker contacts a bottom plane or an upper plane of a roof, the nail 2 is separated from the guider 200 of the tacker, such as a nailer, and drops through an outlet of the tacker.

Therefore, the conventional tacker comprises a magnetic member 300 for temporarily fixing the final nail 2, which remains in the guider 200, so that the nail 2 is not separated from the tacker through the outlet of the tacker.

In the above conventional tackers each provided with the magnetic member 300, iron filings are separated from a nail-loading coil (not shown), which fixes a plurality of nails 2 for aligning the nails 2 in a line in a magazine (not shown), and are attracted to the magnetic member 300. The above iron filings, which are attracted to the magnetic member 300, prevent the tacker from launching nails, thereby causing failure of the tacker and inconvenience in repairing the tacker.

### SUMMARY OF THE INVENTION

Therefore, the present invention has been made in view of the above problems, and it is an object of the present invention to provide a nail retainer, for a tacker, having a guide with a through hole formed through the upper end thereof and a stopper connected to the guide via the through hole for preventing the final remaining nail from dropping, instead of a magnetic member attracting nails, so as to prevent the nail from dropping before firing.

In accordance with the present invention, the above and other objects can be accomplished by the provision of a nail retainer for a tacker comprising: a guider receiving nails transmitted from a magazine, guiding the nails received therein, and comprising a hole formed through a designated portion of the upper surface thereof; and a stopper axially connected to the hole of the guider, moving together with the movement of a contact arm to prevent the nails received in the guider from dropping when the contact arm moves forward, and releasing a nail-stopping motion for preventing the nails from dropping when the contact arm moves backward.

Preferably, a coil spring is connected to one end of the stopper to maintain an anti-nail dropping position of the stopper.

Further, preferably, the stopper has a triangular shape and structured such that the stopper is released from the anti-nail dropping position for ejecting the nails when the contact arm moves backward.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a partial transversal sectional view of a conventional tacker;

FIG. 2 is a transversal sectional view of a nail retainer for the conventional tacker;

FIGS. 3A and 3B illustrate nail-firing and resetting states of a tacker in accordance with an embodiment of the present invention; and

FIGS. 4A, 4B, and 4C are transversal sectional views illustrating an operating state of a nail retainer for the tacker in accordance with the embodiment of the present invention.

### DESCRIPTION OF THE PREFERRED EMBODIMENTS

Now, a preferred embodiment of the present invention will be described in detail with reference to the annexed drawings.

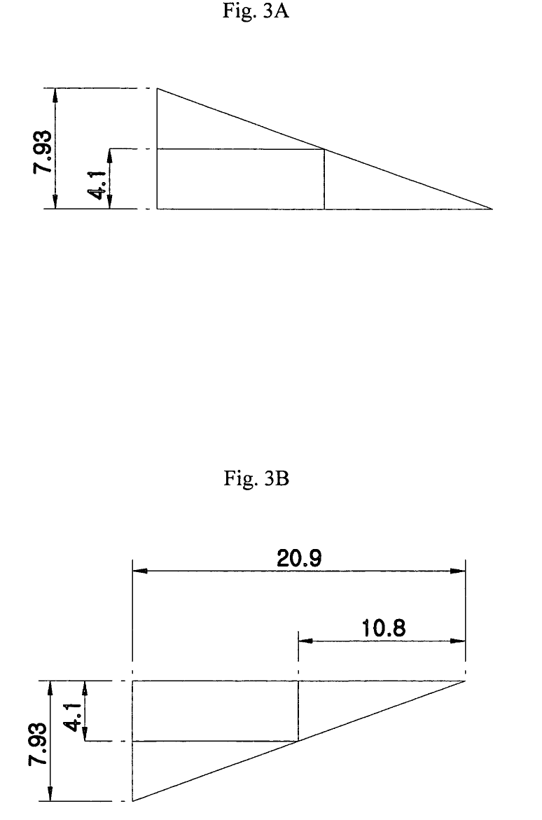

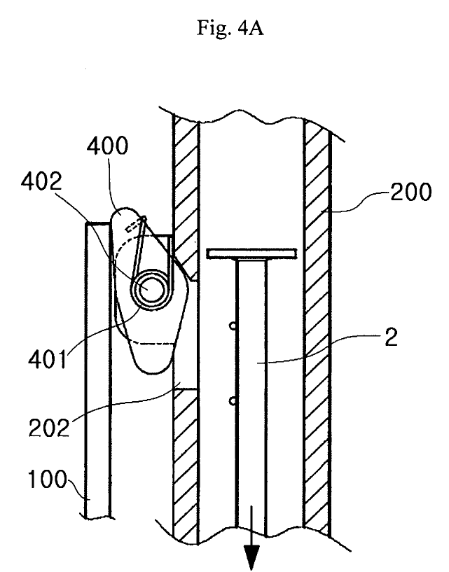

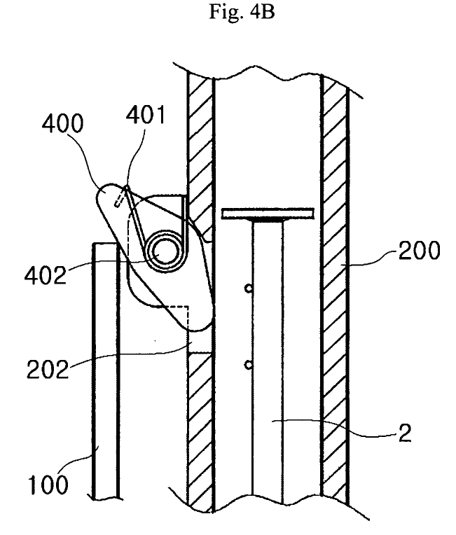

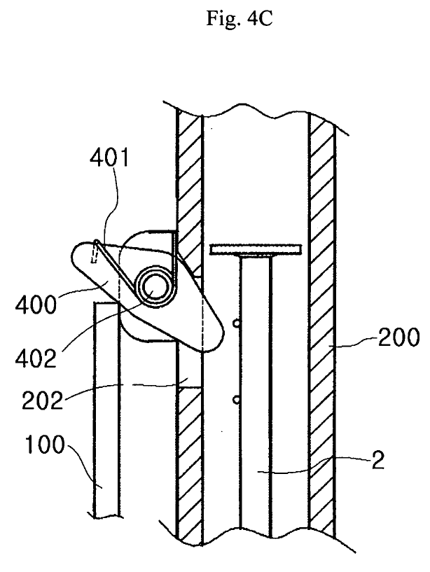

FIGS. 3A and 3B illustrate nail-firing and resetting states of a tacker in accordance with an embodiment of the present invention. FIGS. 4A, 4B, and 4C are transversal sectional views illustrating an operating state of a nail retainer for the tacker in accordance with the embodiment of the present invention.

With reference to FIGS. 3A and 3B and FIGS. 4A, 4B, and 4C, the tacker in accordance with the embodiment of the present invention comprises a nail retainer taking the place of a magnetic member attracting nails. The above nail retainer comprises a stopper connected to a through hole formed through the upper end of a guide for preventing the nail from dropping before firing.

The tacker in accordance with the embodiment of the present invention comprises a guider 200, which receives nails 2 transmitted from a magazine, guides the nails 2, and has a hole 202 formed through a designated portion of the upper surface thereof.

The tacker in accordance with the embodiment of the present invention further comprises a stopper 400, which is axially connected to the hole 202 of the guider 200, moves together with the movement of a contact arm 100 to prevent the nail 2 received in the guider 200 from dropping when the contact arm 100 moves forward, and releases a stopping motion for preventing the nail 2 from dropping when the contact arm 100 moves backward.

A coil spring 401 is connected to one end of the stopper 400, and maintains an anti-dropping position for preventing the nail 2 from dropping. The stopper 400 has a triangular shape and is structured such that the stopper 400 is released from the anti-dropping position so that the nail 2 is ejected from the guider 200 when the contact arm 100 moves backward.

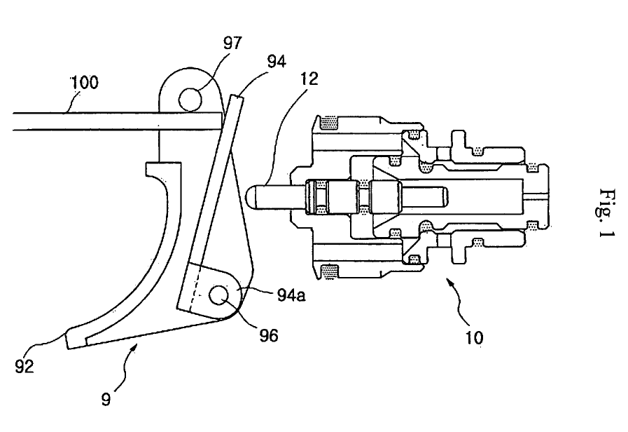

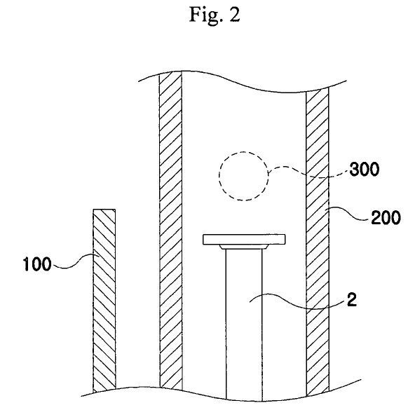

The above shape of the stopper 400 relates to the mechanism of the contact arm 100. As shown in FIGS. 3A and 3B, the trigger of the conventional tacker (JIT 500 series) is pulled to a firing position when the valve rod 12 (with reference with FIG. 1) moves backward by a distance of approximately 4.1 mm, and is reset to its original position when the valve rod 12 moves forward by a distance of approximately 3.2 mm. The movement distance of the contact arm 100 is 7.9 mm at the firing position, and 6.2 mm at the reset position, and the stroke of the contact arm 100 is 8.7 mm. The stopper 400 for the tracker of the present invention is designed using the above mechanism.

Therefore, the stopper 400 is rotated by the coil spring 401, thereby preventing the nail 2 received in the guider 200 from dropping when the contact arm 100 moves forward. Further, the stopper 400 contacts the contact arm 100 at the position of a target object, and is pressed by the contact arm 100 and rotated when the contact arm 100 moves backward, thereby releasing its stopping motion.

The stopper 400 of the tacker of the present invention, differing from the conventional anti-dropping member made of a magnetic material, does not attract iron filings remaining in a magazine or the guider 200, thereby not causing failure. Further, the stopper 400 of the tacker of the present invention performs a nail-stopping motion for preventing the nail 2 from dropping based on the movement of the contact arm 100, thereby drastically reducing the failure rate and increasing the consumer's reliability to the tacker.

As apparent from the above description, the present invention provides a nail retainer for a tacker, which does not cause failure due to the attraction of iron filings remaining in a magazine or a guider onto the surface of the member, differing from conventional nail retainers made of a magnetic material, and moves together with the movement of a contact arm to reliably prevent a nail from dropping, thereby increasing the consumer's reliability.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A nail retainer for a tacker comprising:
a guider receiving nails transmitted from a magazine, guiding the nails received therein, and comprising a hole formed through a designated portion of the upper surface thereof; and
a stopper axially connected to the hole of the guider, moving together with the movement of a contact arm to prevent the nails received in the guider from dropping when the contact arm moves forward, and releasing a nail-stopping motion for preventing the nails from dropping when the contact arm moves backward.

2. The nail retainer as set forth in claim 1, wherein a coil spring is connected to one end of the stopper to maintain an anti-nail dropping position of the stopper.

3. The nail retainer as set forth in claim 1, wherein the stopper has a triangular shape and is structured such that the stopper is released from the anti-nail dropping position for ejecting the nails when the contact arm moves backward.
